(19) United States
(12) Patent Application Publication
(10) Pub. No.: US 2021/0291212 A1
(43) Pub. Date: Sep. 23, 2021

(54) PUMP WITH LEFT AND RIGHT LOCKING STRUCTURE AND EXTERNAL SPRING

(71) Applicant: MAJESTY PACKAGING SYSTEMS LIMITED, Zhongshan City (CN)

(72) Inventors: Peihui LIANG, Zhongshan City (CN); Maoyong ZHU, Zhongshan City (CN); Yonglei ZHANG, Zhongshan City (CN); Junhan HUANG, Zhongshan City (CN)

(73) Assignee: MAJESTY PACKAGING SYSTEMS LIMITED, Zhongshan City, GD (CN)

(21) Appl. No.: 17/268,414

(22) PCT Filed: Apr. 2, 2020
(86) PCT No.: PCT/CN2020/082935

§ 371 Date: Feb. 12, 2021

(30) Foreign Application Priority Data
Mar. 20, 2020 (CN) 202010202319.8

(51) Int. Cl. B05B 11/00

(52) U.S. Cl. CPC B05B 11/306; B05B 11/3074; B05B 11/3047; B05B 11/3023

(57) ABSTRACT

The invention discloses a pump with a left and right locking structure and an external spring, which includes a pump body extending into a bottle body, a pump chamber is arranged on the pump body, a locking bottle cover is connected to the pump body, a pumping member is arranged in the pump chamber, a locking cover is provided at an inner wall of the pump chamber, a one-way valve is provided at a lower end of the pump chamber, a bent nozzle is provided at an upper end of the pumping member, a liquid guiding pipe capable of extending into the bottle body is arranged on the pump body and located below the one-way valve, the pumping member includes a pump rod, a liquid inlet hole is formed below the pump rod, a piston is sleeved on the pump rod, an air inlet hole is formed in the pump body, a pushing part is arranged on the pump rod, the locking cover is further provided with a limiting protruding block, and a reset spring is arranged between the locking cover and the bent nozzle; and a limiting member capable of preventing the bent nozzle from being pressed downward when the pump rod is rotated by a certain angle is arranged between the pump rod and the locking cover. According to the invention, the bent nozzle can be prevented from being mistakenly pressed in a transportation process by arranging the limiting member, leakage is avoided, meanwhile, the air inlet hole is sealed through cooperation of the piston and the locking cover, and a sealing effect is enhanced.

### TECHNICAL FIELD

The present invention relates to a pump with a left and right locking structure and an external spring.

### BACKGROUND

Due to an exquisite design and a convenient use, the emulsion pump has been widely used in daily chemical and pharmaceutical industries. However, an existing emulsion pump has many parts and a complex structure, and is difficult in manufacturing and high in production cost. Moreover, a reset spring of a pumping member of a traditional emulsion pump may directly contact with an emulsion in a pump chamber, and when a return spring rusts, the liquid may be polluted, thus being unsanitary. Moreover, a bent nozzle of the existing emulsion pump is easy to be mistakenly pressed during use, resulting in waste or inconvenience to a user. In order to stabilize an air pressure in a bottle body during operation, the existing emulsion pump is always provided with an air inlet hole, but the emulsion in the bottle body may be inevitably leaked from the air inlet hole during transportation, thus causing pollution and affecting the use.

The present invention is provided for overcoming the above shortcomings.

### SUMMARY

The technical problem to be solved by the present invention is to provide a pump with a left and right locking structure and an external spring, a bent nozzle may be prevented from being mistakenly pressed in a transportation process by arranging a limiting member, leakage is avoided, meanwhile, an air inlet hole is sealed through cooperation of a piston and a locking cover, thereby improving the sealing effect.

In order to solve the above technical problem, the following technical schemes are used in the present invention: a pump with a left and right locking structure and an external spring comprises a pump body extending into a bottle body, wherein a pump chamber is arranged on the pump body, a locking bottle cover capable of fixing the pump body on the bottle body is connected to the pump body, a pumping member is arranged in the pump chamber, a locking cover capable of preventing the pumping member from being separated from the pump chamber is provided at an inner wall of the pump chamber, a one-way valve is provided at a lower end of the pump chamber, a bent nozzle is provided at an upper end of the pumping member, a liquid guiding pipe capable of extending into the bottle body is arranged on the pump body and located below the one-way valve, the pumping member comprises a pump rod capable of penetrating through the locking cover and having a pumping channel, a liquid inlet hole communicated with the pumping channel is formed below the pump rod, a piston capable of sliding relative to the pump rod and blocking or opening the liquid inlet hole is sleeved on the pump rod, an air inlet hole capable of being sealed or opened by the piston is formed in the pump body, in the embodiment, a gap exists between the pump rod and the locking cover, when the pump rod drives the piston to move down, external air enters the bottle body through the gap between the pump rod and the locking cover first and then through the air inlet hole, thus ensuring a normal air pressure in the bottle body during operation, a pushing part capable of pushing the piston downwards to communicate the air inlet hole with the outside when the pump chamber is communicated with the pumping channel is arranged on the pump rod, the locking cover is further provided with a limiting protruding block capable of preventing the piston from moving upwards when the piston seals the air inlet hole, and a reset spring is arranged between the locking cover and the bent nozzle; and a limiting member capable of preventing the bent nozzle from being pressed downward when the pump rod is rotated by a certain angle is arranged between the pump rod and the locking cover.

According to the above pump with a left and right locking structure and an external spring, the limiting member comprises a convex rib vertically arranged on an outside wall of the pump rod, a guiding groove allowing the convex rib to slide up and down in the guiding groove is arranged on an inner wall of the locking cover, and a boss used for abutting against the convex rib and preventing the convex rib from sliding downwards after the pump rod is rotated by a certain angle is arranged on the inner wall of the locking cover.

According to the above pump with a left and right locking structure and an external spring, a clamping part is arranged outside the locking cover, and a positioning connecting part for clamping the clamping part is arranged in the pump body.

According to the above pump with a left and right locking structure and an external spring, a limiting convex ring capable of abutting against a lower part of the piston is arranged on an outer wall of the pump rod located below the liquid inlet hole, the pushing part is arranged above the liquid inlet hole, and the piston is arranged between the pushing part and the limiting convex ring.

According to the above pump with a left and right locking structure and an external spring, anti-rotation teeth used for fixing the pump rod and the bent nozzle after the pump rod is connected to the bent nozzle are provided at an upper end of the pump rod.

According to the above pump with a left and right locking structure and an external spring, two convex ribs are vertically arranged on the outside wall of the pump rod, and two guiding grooves matched with the convex ribs are arranged on the inner wall of the locking cover.

According to the above pump with a left and right locking structure and an external spring, a gasket is also arranged in the locking bottle cover, and the gasket has an annular structure.

According to the above pump with a left and right locking structure and an external spring, the lower end of the pump chamber is conical, the one-way valve is a pump bead arranged at the lower end of the pump chamber, and the pump chamber is provided with a limiting claw for preventing the one-way valve from being separated.

Compared with the prior art, the pump with a left and right locking structure and an external spring of the present invention has the following effects.

1. According to the present invention, when the bent nozzle is pressed down for the first time, the pump rod moves down, the pumping channel is communicated with the pump chamber, during a process that the pump rod drives the piston to move down, air in the pump chamber may be discharged from the pumping channel, the bent nozzle is released, at the moment, a negative pressure is formed in the pump chamber, the liquid in the bottle body pushes and opens the one-way valve and enters the pump chamber, the bent nozzle is pressed down again, the pumping channel is communicated with the pump chamber, the pump rod drives the piston to move down, since the gap exists between the pump rod and the locking cover, external air enters the air inlet hole through the gap, so that the air inlet hole is communicated with the outside, thereby ensuring a stable air pressure during operation, the liquid in the pump chamber is ejected from the pumping channel to complete liquid discharge, and in a free state, the piston abuts against the locking cover to seal the air inlet hole, thereby preventing the liquid in the bottle body from leaking from the air inlet hole, and achieving a good sealing performance; and the limiting member capable of preventing the bent nozzle from being pressed down when the pump rod is rotated by a certain angle is arranged between the pump rod and the locking cover, a guide rail on the pump rod is matched with a receding groove on the locking cover to realize self-locking, and the bent nozzle cannot be pressed down, thereby avoiding the liquid from being squeezed and leaked when the emulsion pump is not in use.

2. The reset spring of the present invention is arranged between an upper end face of the locking cover and the bent nozzle, and is arranged above the piston, so that when the pumping member moves up and down to suck the emulsion into the pump chamber below the piston, the reset spring may not be contaminated by the emulsion. Therefore, the structure of the present invention enables the reset spring and the emulsion to be completely separated, thereby ensuring sanitation without polluting the emulsion.

3. The locking cover and the pump body of the present invention are matched and clamped with the positioning connecting part through the clamping part, and connection is stable, so that the locking cover is prevented from being separated from the pump body, thereby preventing the pumping member from being separated from the pump chamber.

### BRIEF DESCRIPTION OF THE DRAWINGS

The specific embodiments of the present invention are further described hereinafter with reference to the accompanying drawings, in which:

FIG. 1 is a perspective view of the present invention;

FIG. 2 is an exploded view of the present invention;

FIG. 3 is a cross-section view of a bent nozzle without being pressed down according to the present invention;

FIG. 4 is an enlarged view of a part A in FIG. 3;

FIG. 5 is a cross-section view of a bent nozzle pressed down according to the present invention;

and

FIG. 6 is a schematic structure diagram of a locking cover of the present invention.

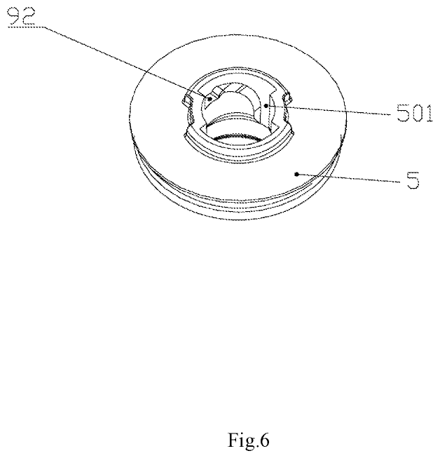

In which:
1. pump body; 11. air inlet hole; 12. positioning connecting part; 2. pump chamber; 21. limiting claw; 3. locking bottle cover; 4. pumping member; 401. pumping channel; 41. pump rod; 411. pushing part; 412. limiting convex ring; 413. anti-rotation teeth; 402. liquid inlet hole; 42. piston; 43. reset spring; 5. locking cover; 501. guiding groove; 51. limiting protruding block; 52. clamping part; 6. one-way valve; 7. bent nozzle; 8. liquid guiding pipe; 9. limiting member; 91. convex rib; 92. boss; and 10. gasket.

### DETAILED DESCRIPTION

The technical solutions in the embodiments of the present invention are clearly and completely described hereinafter with reference to the accompanying drawings in the embodiments of the present invention.

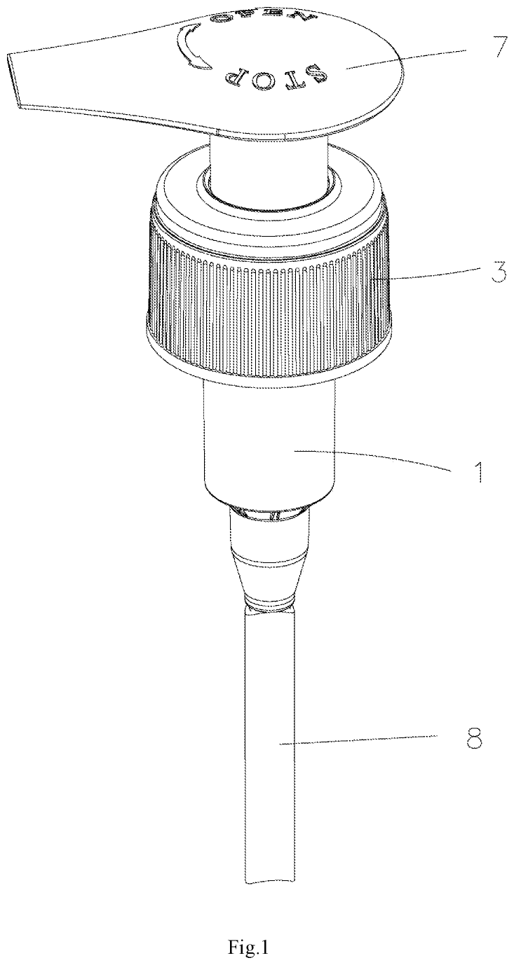

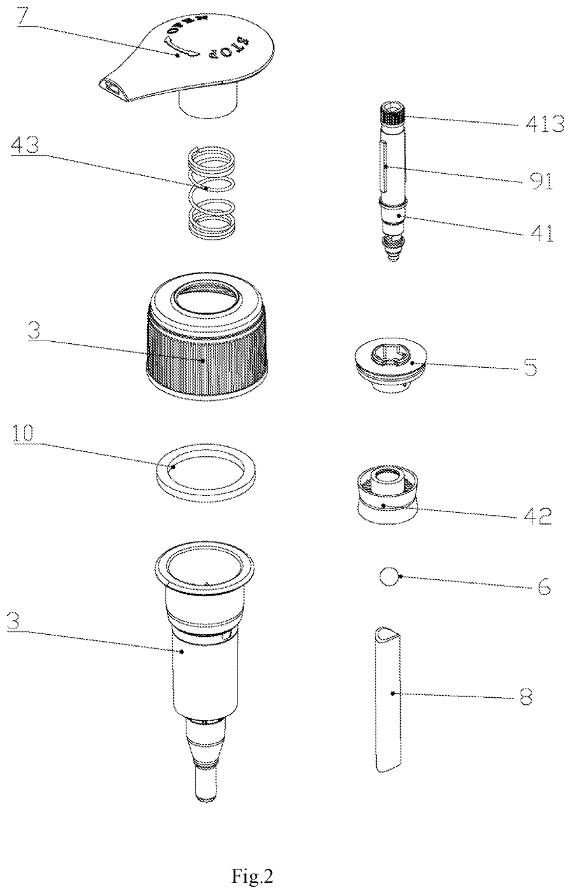

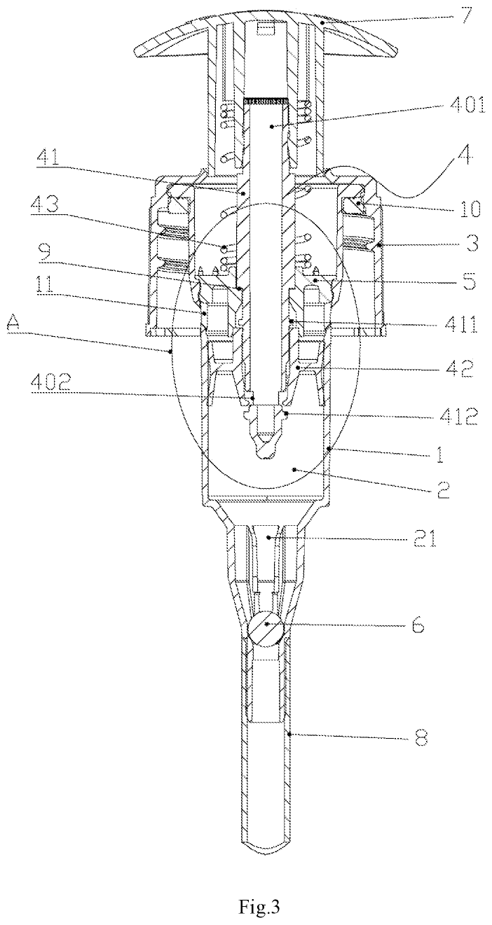

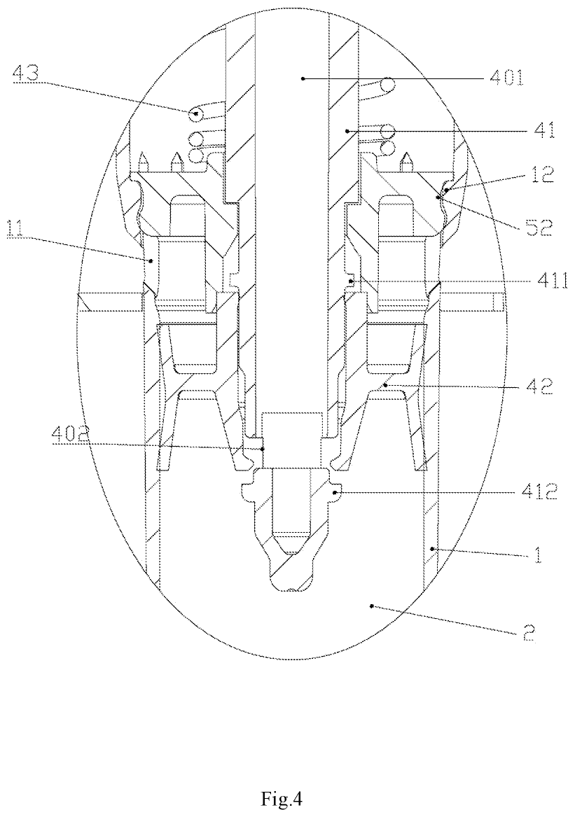

As shown in FIG. 1 to FIG. 5, a pump with a left and right locking structure and an external spring comprises a pump body 1 extending into a bottle body, wherein a pump chamber 2 is arranged on the pump body 1, a locking bottle cover 3 capable of fixing the pump body on the bottle body is connected to the pump body 1, and a pumping member 4 is arranged in the pump chamber 2. A locking cover 5 capable of preventing the pumping member 4 from being separated from the pump chamber 2 is provided at an inner wall of the pump chamber 2, a lower end of the pump chamber 2 is provided with a one-way valve 6, a bent nozzle 7 is provided at an upper end of the pumping member 4, and a liquid guiding pipe 8 capable of extending into the bottle body is arranged on the pump body 1 and located below the one-way valve 6. The pumping member 4 comprises a pump rod 41 capable of penetrating through the locking cover 5 and having a pumping channel 401, a liquid inlet hole 402 communicated with the pumping channel 401 is formed below the pump rod 41, a piston 42 capable of sliding relative to the pump rod and blocking or opening the liquid inlet hole 402 is sleeved on the pump rod 41, and an air inlet hole 11 capable of being sealed or opened by the piston 42 is formed in the pump body 1. A pushing part 411 capable of pushing the piston 42 downwards to communicate the air inlet hole 11 with the outside when the pump chamber 2 is communicated with the pumping channel 401 is arranged on the pump rod 41, the locking cover 5 is further provided with a limiting protruding block 51 capable of preventing the piston from moving upwards when the piston seals the air inlet hole, and a reset spring 43 is arranged between the locking cover 5 and the bent nozzle 7. A limiting member 9 capable of preventing the bent nozzle 7 from being pressed downwards when the pump rod 41 is rotated by a certain angle is arranged between the pump rod 41 and the locking cover 5. According to the present invention, when the bent nozzle is pressed down for the first time, the pump rod moves down, and the pumping channel is communicated with the pump chamber. During a process that the pump rod drives the piston to move down, air in the pump chamber may be discharged from the pumping channel, the bent nozzle is released, and at the moment, a negative pressure is formed in the pump chamber. A liquid in the bottle body pushes and opens the one-way valve and enters the pump chamber, the bent nozzle is pressed down again, the pumping channel is communicated with the pump chamber, and the pump rod drives the piston to move down, so that the air inlet hole is communicated with the outside, thereby ensuring a stable air pressure during operation. The liquid in the pump chamber is ejected from the pumping channel to complete liquid discharge, and in a free state, the piston abuts against the locking cover to seal the air inlet hole, thereby preventing the liquid in the bottle body from leaking from the air inlet hole, and achieving a good sealing performance. The limiting member capable of preventing the bent nozzle from being pressed down when the pump rod is rotated by a certain angle is arranged between the pump rod and the locking cover, a guide rail on the pump rod is matched with a receding groove on the locking cover to realize self-locking, and the bent nozzle cannot be pressed down, thereby avoiding the liquid from being squeezed and leaked when the emulsion pump is not in use.

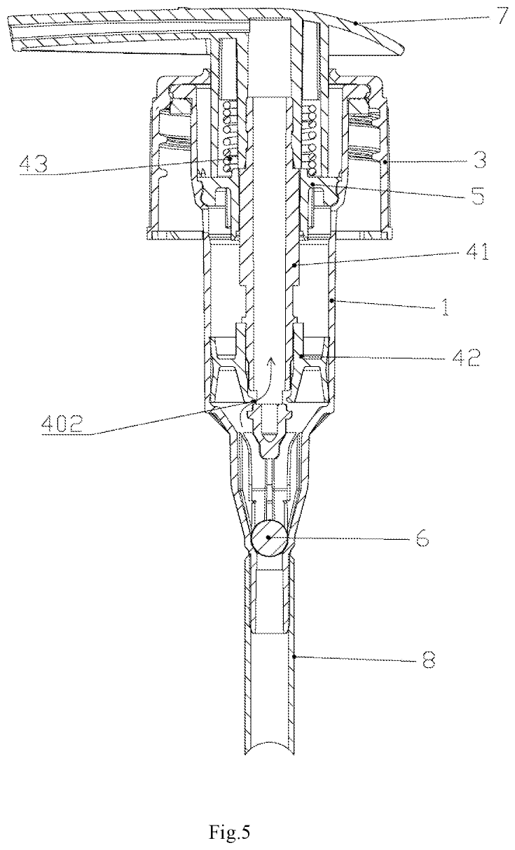

As shown in FIG. 1 and FIG. 5, in the embodiment, the limiting member 9 comprises a convex rib 91 vertically arranged on an outside wall of the pump rod 41, a guiding groove 501 allowing the convex rib 91 to slide up and down in the guiding groove is arranged on an inner wall of the locking cover 5, and a boss 92 used for abutting against the convex rib 91 and preventing the convex rib 91 from sliding downwards after the pump rod 41 is rotated by a certain angle is arranged on the inner wall of the locking cover 5. The convex rib on the pump rod enters the boss by rotating the bent nozzle, so that the bent nozzle is limited from being pressed down, and the bent nozzle is rotated again to make the convex rib on the pump rod enter the guiding groove, thus unlocking and pressing down the bent nozzle.

As shown in FIG. 1 and FIG. 5, in the embodiment, a clamping part 52 is arranged outside the locking cover 5, and a positioning connecting part 21 for clamping the clamping part 52 is arranged in the pump body 1. The locking cover is prevented from being separated from the pump body during the operation of the bent nozzle, thereby preventing the pumping member from being separated from the pump chamber, and ensuring a connection stability.

As shown in FIG. 1 and FIG. 5, in the embodiment, a limiting convex ring 412 capable of abutting against a lower part of the piston 42 is arranged on an outer wall of the pump rod 41 located below the liquid inlet hole 402, the pushing part 411 is located above the liquid inlet hole 402, and the piston 42 is located between the pushing part 411 and the limiting convex ring 412. The pump rod is ensured to seal the liquid inlet hole with the piston in a process of moving up.

As shown in FIG. 1 and FIG. 5, in the embodiment, anti-rotation teeth 413 used for fixing the pump rod and the bent nozzle after the pump rod is connected to the bent nozzle 7 are provided at an upper end of the pump rod 41. The pump rod is ensured to be rotated together while rotating the bent nozzle, and then the bent nozzle is unlocked or locked.

As shown in FIG. 1 and FIG. 5, in the embodiment, two convex ribs 91 are vertically arranged on the outside wall of the pump rod 41, and two guiding grooves 501 matched with the convex ribs 91 are arranged on the inner wall of the locking cover 5. Smoothness of pressing down of the bent nozzle is improved.

As shown in FIG. 1 and FIG. 5, in the embodiment, a gasket 10 is also arrange in the locking bottle cover 3, and the gasket 10 has an annular structure. The gasket plays a role of sealing the bottle body.

As shown in FIG. 1 to FIG. 5, in the embodiment, the lower end of the pump chamber 2 is conical, and the one-way valve 6 is a pump bead arranged at the lower end of the pump chamber 2. The pump chamber 2 is provided with a limiting claw 21 for preventing the one-way valve 6 from being separated, thus preventing the one-way valve from being separated.

Operating Principle

1. The bent nozzle is pressed down to overcome an elasticity of the reset spring to drive the pump rod to move down, and the piston has friction lag with the pump chamber, and at the moment, the channel between the pump rod and the piston is opened. If the pump rod continues to move down, the pump rod holds the piston to move down together, and local air in an inner cavity of the pump chamber may be discharged from the pumping channel.

2. When the bent nozzle is released, the pump rod moves up under an action of a force of the reset spring, the piston lags behind, the channel between the piston and the pump rod is sealed instantly, and partial vacuum is formed in the inner cavity of the pump chamber. Under an action of an atmospheric pressure, a solution may be introduced from the liquid guiding pipe and sucked into the inner cavity of the pump chamber after flushing away the pump bead, and the solution may be ejected from the bent nozzle when the bent nozzle is pressed continuously.

What is claimed is:

1. A pump with a left and right locking structure and an external spring, comprising a pump body (1) extending into a bottle body, wherein a pump chamber (2) is arranged on the pump body (1), a locking bottle cover (3) capable of fixing the pump body on the bottle body is connected to the pump body (1), a pumping member (4) is arranged in the pump chamber (2), a locking cover (5) capable of preventing the pumping member (4) from being separated from the pump chamber (2) is provided at an inner wall of the pump chamber (2), a one-way valve (6) is provided at a lower end of the pump chamber (2), a bent nozzle (7) is provided at an upper end of the pumping member (4), a liquid guiding pipe (8) capable of extending into the bottle body is arranged on the pump body (1) and located below the one-way valve (6), wherein the pumping member (4) comprises a pump rod (41) capable of penetrating through the locking cover (5) and having a pumping channel (401), a liquid inlet hole (402) communicated with the pumping channel (401) is formed below the pump rod (41), a piston (42) capable of sliding relative to the pump rod (41) and blocking or opening the liquid inlet hole (402) is sleeved on the pump rod (41), an air inlet hole (11) capable of being sealed or opened by the piston (42) is formed in the pump body (1), a pushing part (411) capable of pushing the piston (42) downward to communicate the air inlet hole (11) with the outside when the pump chamber (2) is communicated with the pumping channel (401) is arranged on the pump rod (41), the locking cover (5) is further provided with a limiting protruding block (51) capable of preventing the piston from moving upward when the piston seals the air inlet hole (11), and a reset spring (43) is arranged between the locking cover (5) and the bent nozzle (7); and a limiting member (9) capable of preventing the bent nozzle (7) from being pressed downward when the pump rod (41) is rotated by a certain angle is arranged between the pump rod (41) and the locking cover (5).

2. The pump of claim 1, wherein the limiting member (9) comprises a convex rib (91) vertically arranged on an outside wall of the pump rod (41), a guiding groove (501) allowing the convex rib (91) to slide up and down in the guiding groove is arranged on an inner wall of the locking cover (5), and a boss (92) used for abutting against the convex rib (91) and preventing the convex rib (91) from sliding downwards after the pump rod (41) is rotated by a certain angle is arranged on the inner wall of the locking cover (5).

3. The pump of claim 1, wherein a clamping part (52) is arranged outside the locking cover (5), and a positioning connecting part (12) for clamping the clamping part (52) is arranged in the pump body (1).

4. The pump of claim 1, wherein a limiting convex ring (412) capable of abutting against a lower part of the piston (42) is arranged on an outer wall of the pump rod (41) located below the liquid inlet hole (402), the pushing part (411) is arranged above the liquid inlet hole (402), and the piston (42) is arranged between the pushing part (411) and the limiting convex ring (412).

5. The pump of claim 1, wherein anti-rotation teeth (413) used for fixing the pump rod and the bent nozzle after the pump rod is connected to the bent nozzle (7) are provided at an upper end of the pump rod (41).

6. The pump of claim 2, wherein two convex ribs (91) are vertically arranged on the outside wall of the pump rod (41), and two guiding grooves (501) matched with the convex ribs (91) are arranged on the inner wall of the locking cover (5).

7. The pump of claim 1, wherein a gasket (9) is arranged in the locking bottle cover (3), and the gasket (9) has an annular structure.

8. The pump of claim 1, wherein the lower end of the pump chamber (2) is conical, the one-way valve (6) is a pump bead arranged at the lower end of the pump chamber (2), and the pump chamber (2) is provided with a limiting claw (21) for preventing the one-way valve (6) from being separated.
